(19) United States
(12) Patent Application Publication
(10) Pub. No.: US 2025/0355448 A1
(43) Pub. Date: Nov. 20, 2025

(54) Multi-Agent Navigation

(71) Applicant: Tencent America LLC, Palo Alto, CA (US)

(72) Inventors: Zherong Pan, Palo Alto, CA (US); Xifeng Gao, Palo Alto, CA (US); Kui Wu, Palo Alto, CA (US)

(21) Appl. No.: 18/666,064

(22) Filed: May 16, 2024

(51) Int. Cl. G05D 1/69; G05D 1/644; G05D 101/15; G05D 109/10

(52) U.S. Cl. CPC G05D 1/69; G05D 1/644; G05D 2101/15; G05D 2109/10

(57) ABSTRACT

Described herein is a method of performing autonomous navigation by deploying one or more nodes over a predetermined space such that the one or more nodes is trained based on predetermined set of traffic rules; deploying one or more agents in the predetermined space; determining a destination for each of the one or more agents; determining a path to the destination; querying at least one of the nodes associated with at least one of corresponding regions encompass a current position of the corresponding one or more agents; determining, by at least one of the nodes, a direction of travel; sending the preferred direction of travel to the corresponding one or more agents; enabling the corresponding one or more agents to travel in the preferred direction; and determining the current position of the corresponding one or more agents is equal to the assigned destination or not.

### FIELD OF THE INVENTION

Embodiments disclosed herein relate, in general, to a navigation system, and more particularly, to multi-agent navigation systems and methods.

### BACKGROUND

Multi-agent navigation is crucial in various robotic applications, such as automated warehousing, autonomous driving, and smart cities. Despite significant research focus over the years, developing an ideal navigation algorithm that achieves scalability, generality, and efficacy without a substantial increase in computational and deployment cost remains a challenge. A successful navigation algorithm relies on an effective strategy for managing agent congestion. Some traditional methods, such as a back-tracking search or a localized collision-avoidance demonstrated notable generality but faced scalability and efficacy issues. While local navigation policies accomplish some scalability, they often lack generality, leading to congestion. Moreover, effective communication capabilities are required for the agents to coordinate, making a system demanding in terms of both computation and communication.

Therefore, there is a need for an improved navigation system and method for multi-agents that surpasses constraints of conventional methods, and addresses challenges faced by the existing navigation algorithms.

### SUMMARY

Embodiments described herein provide methods of performing autonomous navigation, e.g., comprising: deploying one or more nodes over a predetermined space, wherein each of the one or more nodes is associated with corresponding one or more regions of the predetermined space such that each of the one or more nodes is trained based on a predetermined set of traffic rules; deploying one or more agents in the predetermined space, wherein each of the one or more agents is associated with a starting location; determining a destination for each of the one or more agents; determining, by each of the one or more agents, a path to the destination assigned to the corresponding one or more agents; querying at least one of the nodes associated with at least one of the corresponding regions encompass a current position of the corresponding one or more agents, to determine a direction of travel; determining, by at least one of the nodes, a preferred direction of travel for the corresponding one or more agents based on the predetermined set of traffic rules; sending the preferred direction of travel from the at least one of the nodes to the corresponding one or more agents; enabling the corresponding one or more agents to travel in the preferred direction from the current position to the destination; and determining the current position of the corresponding one or more agents is equal to the assigned destination or not.

Further aspects described herein may provide a multi-agent navigation system. The system may include a navigation implementation module configured to deploy one or more nodes over a predetermined space, wherein each of the one or more nodes are associated with corresponding one or more regions of the predetermined space; train each of the one or more nodes by using predetermined set of traffic rules stored in a database; deploy one or more agents within the predetermined space, wherein each of the one or more agents is associated with a starting location; and determine a destination for each of the one or more agents. The system may further include: a path calculation module configured to enable the one or more agents to determine a path to the destination assigned to the corresponding one or more agents. The system may further include a node interaction module configured to: query at least one of the nodes associated with at least one of the corresponding regions encompass a current position of the corresponding one or more agents, to determine a direction of travel; and enable the at least one of the nodes to determine the preferred direction of travel for the corresponding one or more agents based on the predetermined set of traffic rules. The system may further include a communication module configured to transmit the preferred direction of travel from the at least one of the nodes to the corresponding one or more agents. The system may further include a monitoring module configured to determine whether the current position of the corresponding one or more agents is equal to the assigned destination or not.

Further aspects described herein may provide a non-transitory computer readable medium storing instruction that, when executed by a computer, perform any of the methods or configure any of the systems to perform as described herein.

Aspects described herein may provide a number of advantages depending on a particular configuration. First, aspects described herein may provide a multi-agent navigation system that adopts an environment-centric approach. The environment-centric approach may eliminate a need for a runtime inter-agent communication, which may further lead to a significantly reduced computational burden as compared to agent-centric navigation policies.

Next, aspects described herein may provide a multi-agent navigation system that utilizes a learning-based approach, for enabling a coordination of unintelligent agents with basic collision-avoidance capabilities.

Next, aspects described herein may provide a multi-agent navigation system that utilizes a neural network for facilitating an efficient modulation of agent velocities, which in turn contributes to a smoother navigation process and congestion resolution.

Next, aspects described herein may provide a multi-agent navigation system that is capable of handling multiple agents in a real-time (e.g., ˜240 agents) which in turn makes the system applicable in dynamic environments.

Further, aspects described herein may provide a fully decentralized multi-agent navigation system that eliminates a need for an extensive agent coordination, promoting a more distributed and adaptable system.

Next, aspects described herein may provide a multi-agent navigation system where a predetermined space is segmented into distinct regions, facilitating a structured and organized approach to navigation. This segmentation aids in parameterization of traffic rules.

Next, aspects described herein may provide a multi-agent navigation system that utilizes parallel computations to expedite a training process, making the system more practical and efficient for real-world applications.

These and other advantages will be apparent from the present description of the aspects and embodiments described herein.

The preceding is a simplified summary to provide an understanding of some aspects described herein. This summary is neither an extensive nor exhaustive overview of the present application and its various examples. The summary presents selected concepts in a simplified form as an introduction to the more detailed description presented below. As will be appreciated, other examples of the present application are possible utilizing, alone or in combination, one or more of the features set forth above or described in detail below.

### BRIEF DESCRIPTION OF THE DRAWINGS

The foregoing and other aspects of the examples disclosed herein are best understood from the following detailed description when read in connection with the accompanying drawings. For the purpose of illustrating aspects disclosed herein, there is shown in the drawings various aspects that may be used, it being understood, however, that the aspects disclosed herein are not limited to the specific instrumentalities disclosed. Included in the drawings are the following figures:

FIG. 1 illustrates a block diagram of a multi-agent navigation system, according to one or more illustrative aspects described herein;

FIG. 2 illustrates components of a navigation platform of the multi-agent navigation system, according to one or more illustrative aspects described herein;

FIG. 3 illustrates an exemplary environment for navigating multi-agents, according to one or more illustrative aspects described herein;

FIG. 4A illustrates a baseline congestion scenario, according to one or more illustrative aspects described herein;

FIG. 4B illustrates a Reinforcement Learning (RL) congestion scenario, according to one or more illustrative aspects described herein;

FIG. 5A illustrates an Imitation Learning (IL) convergence history, according to one or more illustrative aspects described herein;

FIG. 5B illustrates a Reinforcement Learning (RL) convergence history, according to one or more illustrative aspects described herein;

FIG. 5C illustrates a comparison of runtime total inference cost (in milliseconds) between an environment-centric approach and an agent-centric approach, according to one or more illustrative aspects described herein; and

FIG. 6 illustrates a flow chart of a method of performing autonomous navigation by using the multi-agent navigation system, according to one or more illustrative aspects described herein.

While aspects are described herein by way of example using several illustrative drawings, those skilled in the art will recognize the present application is not limited to the specific examples or drawings described. It should be understood the drawings and the detailed description thereto are not intended to limit the present application to the particular form disclosed, but to the contrary, the present application is to cover all modification, equivalents and alternatives falling within the spirit and scope as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Aspects will be described below in conjunction with an illustrative multi-agent navigation system. Aspects are not limited to any particular type of a multi-agent navigation system. Those skilled in the art will recognize the disclosed techniques may be used in any multi-agent navigation system.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

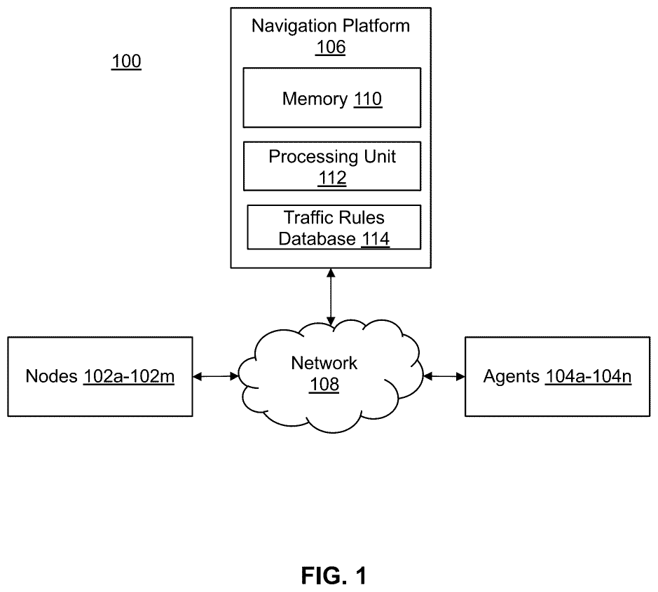

FIG. 1 illustrates a block diagram of an illustrative multi-agent navigation system 100 (hereinafter referred to as the system 100). According to an illustrative aspect, the system 100 may be configured to adopt an environment-centric approach that may eliminate a need for runtime inter-agent communication. The environment-centric approach may lead to a significantly reduced computational burden as compared to an agent-centric navigation approach. As used herein, the “inter-agent communication” refers to an exchange of information, messages, or data between different agents 104a-104n (hereinafter collectively referred to as the agents 104 and individually referred to as the agent 104) within the system 100. According to an aspect described herein, the environment-centric approach may be adopted by the system 100 to handle a large number of agents 104 in real-time which in turn makes the system 100 applicable in dynamic environments.

The environment-centric approach in the system 100 may involve a segmentation strategy, where a predetermined space may be systematically segmented into one or more discrete regions (hereinafter collectively referred to as the regions and individually referred to as the region). The segmentation may enhance an efficiency of the system 100 by creating defined regions. In some aspects, all the regions in the predetermined space may be non-overlapping regions.

In some aspects, each of the regions may be governed by a predetermined set of traffic rules that may be encoded within corresponding nodes 102a-102m (hereinafter collectively referred to as the nodes 102 and individually referred to as the node 102). Each of the regions may encapsulate the predetermined set of traffic rules that may ensure that the agents 104 navigating within the particular region may adhere to the corresponding set of traffic rules encoded in the associated nodes 102.

Further, the system 100 may comprise the nodes 102, the agents 104 and a navigation platform 106. Further, in an example, the nodes 102, the agents 104, and the navigation platform 106 may be connected through a network 108.

According to an aspect, the network 108 may be a data network such as, but not limited to, the Internet, a Local Area Network (LAN), a Wide Area Network (WAN), a Metropolitan Area Network (MAN), a private or enterprise network, and so forth. Aspects are intended to include or otherwise cover any type of the data network, including known, related art, and/or later developed technologies. In some aspects, the network 108 may be a wireless network, such as, but not limited to, a cellular network and may employ various technologies including an Enhanced Data Rates for Global Evolution (EDGE), a General Packet Radio Service (GPRS), and so forth. Aspects are intended to include or otherwise cover any type of wireless network, including known, related art, and/or later developed technologies. In some aspects the nodes 102, the agents 104, and the navigation platform 106 may be configured to communicate with each other by one or more communication mediums connected to the network 108. The communication mediums may be for example, but not limited to, a coaxial cable, a copper wire, a fiber optic, a wire that comprise a system bus coupled to a processor of a computing device, and so forth. Aspects are intended to include or otherwise cover any type of the communication mediums, including known, related art, and/or later developed technologies.

The nodes 102 may be strategically deployed throughout the predetermined space. In other words, the nodes 102 may be associated with the different regions in the predetermined space, and may be responsible for processing information related to the particular region in the predetermined space. The deployment of the nodes 102 across the different regions may allow the system 100 to handle an environment-centric navigation, contributing to a coordinated navigation strategy for the entire system 100.

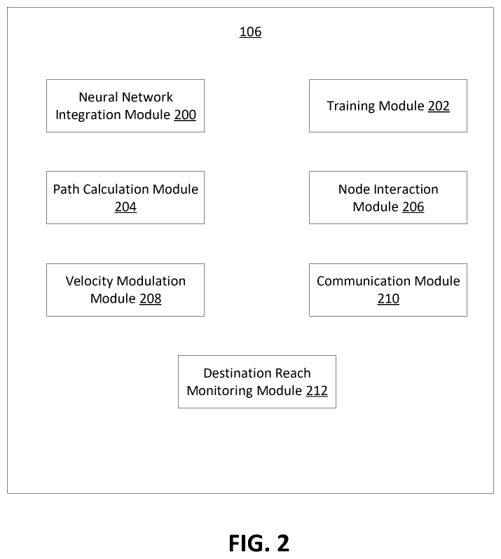

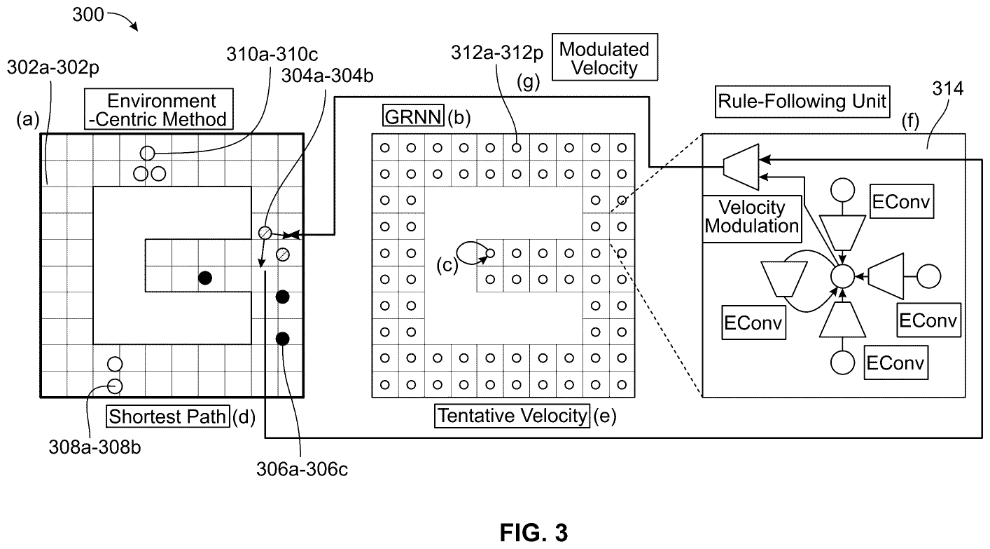

Further, each of the nodes 102 may be computational units that may be trained to process the information and modulate velocities of the corresponding agents 104 within the designated regions. In other words, each of the nodes 102 may learn how to adjust a speed of the agents 104 as the agents 104 move through the corresponding regions in the predetermined space. In addition, each of the nodes 102 may be configured to determine a direction of travel of the corresponding agents 104 within the designated regions. Each of the corresponding agents 104 within the designated region may have an initial direction of travel, and the initial direction of travel may be adjusted by the corresponding node 102. The initial direction of travel may be determined based on a shortest path determined for each of the corresponding agents 104. Additional details about the shortest path are described below in connection with FIGS. 2 and 3.

The nodes 102 may be trained by using the predetermined set of traffic rules. In some aspects, each of the nodes 102 may be trained using the same predetermined set of traffic rules. In other aspects each of the nodes 102 may be trained using a different set of traffic rules. In some aspects the predetermined set of traffic rules may be updated periodically in the nodes 102. In other aspects, each of the nodes 102 may be trained once using the predetermined set of traffic rules, and then the navigation is performed without further retraining. Further, the nodes 102 may be configured to manage and enforce the predetermined set of traffic rules within their respective regions. The nodes 102 may be configured to enable coordination of the agents 104 based on the encoded set of traffic rules.

Each of the nodes 102 may be a part of a computation structure of a neural network. The neural network may be, but not limited to, a feedforward neural network, a recurrent neural network, a deep neural network, and so forth. In one aspect, the neural network may be a Graph Recurrent Neural Network (GRNN). As used herein, the term “GRNN” is an entire neural network architecture, and within the neural network architecture, there are the nodes 102 (GRNN nodes) that may carry out specific computations or hold specific information as part of the overall processing. Aspects described herein are intended to include or otherwise cover any type of the neural network, including known, related art, and/or later developed technologies.

Further, the agents 104 may interact and collaborate within a shared environment. The agents 104 may be for example, but not limited to, physical vehicles, robots, drones, humanoids robots, virtual nodes, simulated agents in a virtual or simulated environment, and so forth. When used on physical agents, the physical vehicles may be autonomous vehicles. Aspects are intended to include or otherwise cover any type of the agents 104, including known, related art, and/or later developed technologies. The agents 104 may have limited processing capabilities due to which, the agent 104 may only be capable to store a current position and destination of the agent 104 in a local memory (not shown) of the agent 104. Further, in some aspects, due to the limited processing capabilities, each of the agents 104 may be incapable to determine a preferred direction of travel to reach the destination within a predetermined time interval. Each agent 104 may have the minimum amount of capacity to compute a local collision free velocity for the agent 104. The local collision free velocity may be determined based on a local navigation algorithm that aims to avoid agent collision while maintaining a minimum distance between the agents. But the local collision free velocity might not predict a velocity to facilitate navigation tasks of the agent while minimizing instances of congestion.

The agents 104 may be deployed in the predetermined space and may be associated with a starting location. The starting location associated with each of the agents 104 may be different from other starting locations of other independent agents of each of the agents 104.

In an illustrative aspect, if the agents 104 are physical agents, then the agents 104 may use communication mediums such as, but not limited to, Bluetooth, RF, Wireless Fidelity (Wi-Fi), Near Field Communication (NFC), and so forth for communicating various types of information with each node. The information may be, but not limited to, current position information, current status information, navigation information, and so forth. Aspects are intended to include or otherwise cover any type of the information that the agents 104 need to communicate. Aspects are intended to include or otherwise cover any type of the communication mediums, including known, related art, and/or later developed technologies.

When the agents 104 are virtual agents, then the agents 104 may rely on a “node manager” to obtain information about the current position. In such example, the “node manager” may function as a central entity (e.g., server) that oversees and coordinates a virtual environment. The “node manager” may keep track of locations of the agents 104 and may act as an intermediary for the agents 104 to access information related to positions of the each of the agents 104. The “node manager” may render one or more agents 104 on a map based on the positions of the one or more agents 104. In an example, the agents 104 may communicate with the “node manager” by sending queries, seeking information about their current position or providing updates about their states and activities.

The navigation platform 106 may comprise a memory 110, a processing unit 112, and a database 114. The navigation platform 106 may be one or more computer readable instructions that may be stored onto the memory 110 and configured to control one or more operations of the system 100. Further, a working of the navigation platform 106 will be explained in detail in conjunction with FIG. 2.

The memory 110 may be a non-transitory data storage medium that may be configured to store computer executable instructions of the navigation platform 106 for controlling the operations of the system 100. The memory 110 may be, but not limited to, a Random-Access Memory device, a Read Only Memory Device, a flash memory, and so forth. Embodiments of the present invention are intended to include or otherwise cover any type of the memory 110 including known, related art, and/or later developed technologies.

Further, the processing unit 112 may be connected to the memory 110 to execute the computer executable instructions of the navigation platform 106 to perform the operations associated with the system 100. The processing unit 112 may be, but not limited to, a Programmable Logic Control unit (PLC), a microcontroller, a microprocessor, a computing device, a development board, and so forth. Aspects are intended to include or otherwise cover any type of the processing unit 112 including known, related art, and/or later developed technologies.

Further, the navigation platform 106 may comprise the database 114 that may be configured to store a training dataset. The training dataset may include a set of scenarios representing various navigation instances within the predetermined space. Each of the scenarios in the training dataset may include information such as, but not limited to, positions of the agents 104 in the predetermined space, destination positions in the predetermined space, the predetermined set of traffic rules, and so forth. In some aspects the navigation platform 106 may comprise multiple databases (not shown) to store the training dataset. The set of traffic rules may be updated periodically for ensuring that it reflects latest regulatory changes, adapts to evolving traffic patterns, and maintains optimal performance in the dynamic environments. The database 114 may be for example, but not limited to, a centralized database, a distributed database, a personal database, an end-user database, a commercial database, a Structured Query Language (SQL) database, a non-SQL database, an operational database, a relational database, a cloud database, an object-oriented database, a graph database, and so forth. Aspects include or otherwise cover any type of the database 114 including known, related art, and/or later developed technologies that may be capable of data storage and retrieval.

FIG. 2 illustrates components of the navigation platform 106 of the system 100, according to aspect described herein. The navigation platform 106 may comprise a navigation implementation module 200, a path calculation module 202, a node interaction module 204, a communication module 206, a velocity modulation module 208, a monitoring module 210, and a storage module 212.

The navigation implementation module 200 may be configured to deploy the nodes 102 over the predetermined space. Each of the nodes 102 may be associated with the corresponding regions of the predetermined space. In other words, each of the nodes 102 may be assigned responsibility for managing and overseeing activities that occur within the corresponding regions, which in turn makes the system 100 a decentralized system.

In another aspect, the navigation implementation module 200 may be configured to train each of the nodes 102 by using the training dataset stored in the database 114 (as shown in the FIG. 1).

The navigation implementation module 200 may be configured to train each of the nodes 102 to determine the velocities of the agents 104 within the corresponding regions. The navigation implementation module 200 may be configured to enable the nodes 102 to learn how to determine the velocities of the agents 104 by considering both spatial context within the corresponding region and the predetermined set of traffic rules. The spatial context may involve inter-agent relationship, information about the specific region in which the corresponding agent 104 is located, understanding of a layout and an arrangement of the predetermined space, as well as positions and movements of the agents 104 within the predetermined space. The spatial context might not involve inter-agent relationship and the navigation implementation module 200 may be configured to enable the agents to operate in a fully decentralized manner, eliminating the need for inter-agent communication. As an example, the inter-agent relationship may refer to distances and relative positions between the different agents 104. Further, as an example, the layout and the arrangement of the predetermined space may include, but not limited to, any obstacles, pathways, or regions that the agents 104 need to navigate through. Aspects are intended to include or otherwise cover any type of the layout and the arrangement of the predetermined space.

Further, the navigation implementation module 200 may be configured to embed the predetermined set of traffic rules in learned parameters of the nodes 102, and may further allow the nodes 102 to make decisions during a real-time navigation that align with the predetermined set of traffic rules. The learned parameters of the nodes 102 may refer to weights and biases that the neural network may adjust during a training process. Such parameters may be adapted to optimize a network's ability to modulate the velocities of the agents 104 based on the spatial context and the predetermined set of traffic rules.

The navigation implementation module 200 may be configured to utilize a supervised learning approach, such as, but not limited to, an Imitation Learning (IL), to train a machine learning model that may be associated with the nodes 102. The machine learning model may be the neural network. Further, the neural network may be, but is not limited to, a deep neural network, a recurrent neural network, a policy gradient method, and so forth. In an illustrative aspect, the neural network may be a Graph Recurrent Neural Network (GRNN). Aspects are intended to include or otherwise cover any type of the neural network including known related art and/or later developed technologies.

In an illustrative aspect, an Imitation Learning (IL) approach may be utilized to train the Graph Recurrent Neural Network (GRNN) for multi-agent navigation. Such process aims to emulate a behavior of an expert with known traffic rules. An IL training may be conducted over a dataset (D) comprising various simulation scenarios (Sᵢ). The simulation scenarios (Sᵢ) may be characterized by a tuple containing a current position (x^{t}ᵢ), a destination (gᵢ), a predicted policy by the model (π(x^{t}ᵢ, gᵢ)), and an expert policy representing a ground truth (π*(x^{t}ᵢ, gᵢ)).

$${ℒ}_{IL} ( {S}_{i} , θ ) = \frac{1}{\vert 𝒟 \vert} {\sum }_{< {x}_{i}^{t} , {g}_{i} > ∈ 𝒟} {\vert π ( {x}_{i}^{t} , {g}_{i} ) - π * ( {x}_{i}^{t} , {g}_{i} ) \vert}^{2} \qquad ( 1 )$$

Equation (1) may represent a loss function, specifically denoted as L_{IL}(Sᵢ, θ), where Sᵢ may be a scenario, and θ may represent a set of parameters or weights associated with the function. Also, |D| may denote a size of the dataset, and summation may be performed over all tuples in the dataset. Further, the term |π(x^{t}ᵢ,gᵢ)−π*(x^{t}ᵢ,gᵢ)|² may calculate a squared Euclidean distance between the predictions of the predicted policy π(x^{t}ᵢ, gᵢ) and the expert policy π*(x^{t}ᵢ, gᵢ)) for each agent 104 in each scenario. The IL training may iteratively adjust the model parameters θ to minimize this loss, ensuring that the GRNN converges towards reproducing the expert's behavior across diverse scenarios within the dataset.

In another aspect, the navigation implementation module 200 may be configured to utilize a Reinforcement Learning (RL) approach, to train the machine learning model that may be associated with the nodes 102. In the RL approach, the machine learning model may learn to make decisions through trial and error. The RL approach may be used when a behavior of an expert with known traffic rules is not available. The RL approach may optimize a policy based on rewards or penalties associated with different actions, allowing the machine learning model to adapt and discover effective traffic rules. The RL approach aims, among other things, to maximize an expected reward by using the below defined equation (2):

$${ℒ}_{RL} ( {S}_{i} , θ ) = {𝔼}_{ϵ ∈ 𝒩 ( 0 , I )} [ R ( {S}_{i} , θ + ϵ ) ] , \qquad ( 2 )$$

where, L_{RL}(Sᵢ, θ) may represent a loss function for a Reinforcement Learning (RL) training process, Sᵢ may represent a specific scenario from the dataset, θ may represent parameters of the machine learning model during the RL, R (Sᵢ, θ+ϵ) may represent the reward obtained in scenario Sᵢ, and ϵ represents a perturbation vector sampled from a normal distribution.

Further, gradient estimators may be described in equation (3) that may provide ways to update model parameters to achieve an objective.

$${∇}_{θ} {ℒ}_{RL} ( {S}_{i} , θ ) = {𝔼}_{ϵ ∈ 𝒩 ( 0 , I )} [ R ( {S}_{i} , θ + ϵ ) ϵ ] / σ \qquad ( 3 )$$

$$\approx 1 {\sum }_{n σ}^{n} R ( {S}_{i} , θ + {ϵ}_{k} ) {ϵ}_{k} ,$$

where ∇_{Θ}L_{RL} (Sᵢ, θ) may represent a gradient of the RL objective with respect to the model parameters θ, σ may denote an estimated standard deviation, n may represent number of samples used for estimating the gradient and Ex may represent perturbation vectors sampled from the normal distribution.

Further, an equation (4) may describe about fitness shaping in the alternative gradient estimator that helps in enhancing performance during the training.

$${∇}_{θ} {ℒ}_{RL} ( {S}_{i} , θ ) \approx {}_{σ}^{1} {\sum }_{k = 1}^{n} {u}_{k} {ϵ}_{k} , \qquad ( 4 )$$

$${u}_{k} {=}^{△} \frac{max ( 0 , log ( \begin{matrix}n \\ 2\end{matrix} + 1 ) - log ( k ) )}{{\sum }_{j = 1}^{n} max ( 0 , log ( \begin{matrix}n \\ 2\end{matrix} + 1 ) - log ( j ) )} - \frac{1}{n}$$

The navigation implementation module 200 may be configured to integrate the learned machine learning models into the nodes 102 associated with the corresponding regions of the predetermined space. The nodes 102 may use the learned traffic rules to guide agent navigation within their specific areas.

Further, the navigation implementation module 200 may be configured to deploy the agents 104 within the predetermined space. The navigation implementation module 200 may be configured to determine the destination for each of the agents 104. In such an aspect, the destination for each of the agents 104 may be determined by considering at least one of various factors. The factors may include, but are not limited to, predefined tasks, dynamic considerations, learning-based approaches, and so forth. Aspects are intended to include or otherwise cover any type of the factors.

In an illustrative aspect, the agent 104 may be assigned a specific task, goal, destination or objective that the agent 104 may need to achieve within the predetermined space. The task may be, but not limited to, reaching a particular point, covering a designated area, achieving a specific mission, and so forth. The destination may be dynamically assigned based on real-time conditions, environmental changes, or status of other agents, or the destination may be predetermined on some other basis. In some aspects, the destinations are determined by the agents. In other aspects, the destinations are determined by non-agents, and the communicated to each agent after determination. In yet another aspect, the agents 104 may communicate with the nodes 102 in the system 100 to receive information about the destination. The destination of each of the agents 104 may be the same, similar, discrete, or otherwise different. Further, the navigation implementation module 200 may be configured to transmit the determined destination to the path calculation module 202.

The path calculation module 202 may be configured to assign the determined destination to the corresponding agents 104 upon receiving the destination from the navigation implementation module 200. The path calculation module 202 may be configured to calculate a shortest path for the agents 104 at each timestep from the current position of the agents 104 to the determined destination. Alternatively, the path calculation module 202 may be configured to enable the agents 104 to determine a path to reach the assigned destination, based on, for example, a determination that the agents 104 have sufficient computational capacity to determine the path. The path calculation module 202 may be configured to enable the agents 104 to determine the path by considering various factors. The factors may be for example, but not limited to, a current position of the agent 104, a location of other agents 104, a layout of the predetermined space, adherence to the trained traffic rules and so forth.

The path calculation module 202 may be configured to enable the agent 104 to undergo a process to calculate a shortest path at each timestep from the current position to the designated destination. The calculation of the shortest path may be carried out by using a visibility graph algorithm. Further, a result of a computation (refers to the process of calculating the shortest path) may be a tentative velocity that represents an optimal speed (e.g., a maximum spend, a default speed) and direction for the agent 104 to follow in order to efficiently reach the destination along a shortest trajectory. The process of calculating the shortest path may be repeated at each timestep to ensure that the agent 104 consistently adjusts its velocity based on the dynamically changing environment and its progress toward the destination. The path calculation module 202 may further be configured to enable the agent 104 to generate a query for the node 102 that may be associated with the region encompassing the current position of the agent 104. The path calculation module 202 may be configured to generate the query for the node 102 for the direction of travel. The path calculation module 202 may be configured to transmit the generated query to the node interaction module 204.

The node interaction module 204 may be configured to identify a nearest region within the predetermined space where the agent 104 is currently located. The node interaction module 204 may be configured to identify the nearest region at each timestep and/or upon receiving the query from the path calculation module 202. The node interaction module 204 may be configured to identify the nearest region within the predetermined space by determining an index of the nearest region for the agent 104 based on its center position. The index of the nearest region may be determined by using an equation (5):

$$I ( {x}_{i}^{t} ) = ⌊ {x}_{i}^{t} ⌋ + 0.5 . \qquad ( 5 )$$

where I may represent an Index of the nearest region and x^{t}ᵢ may represent the center position.

In an example (e.g., in a real-world implementation), the node 102 may identify a nearest region within the predetermined space where the agent 104 is currently located based on the location of the agent 104. Alternatively, the agent 104 itself may identify a nearest region within the predetermined space based on, for example, a GPS associated with the agent 104. As another example, the nearest region within the predetermined space where the agent 104 is currently located may be determined based on a signal strength of the query sent from the agent 104 for the node 102.

Once the region is identified, the node interaction module 204 may be configured to enable the agent 104 to query a Rule-Following Unit (RFU) associated with the determined region. The RFU may be present within the deployed node 102. Further, the node interaction module 204 may be configured to enable the deployed node 102 to generate a response, based on its recurrent connections and the encoded set of traffic rules. The response may comprise a guidance on how the agent 104 needs to be navigating within its respective region and adjustments to the tentative velocities of the agents 104. In other words, the Rule-Following Unit (RFU) may modulate the tentative velocity of the agent 104 based on an internal state of the node 102, the relative position of the agent 104 within the region, and an unmodulated velocity itself. The modulated velocity may be calculated by using a below defined equation (6):

$${v}_{i}^{t} = R F U ( {H}_{I ( {x}_{i}^{t} )}^{K} , {x}_{i}^{t} - I ( {x}_{i}^{t} ) , {\overline{v}}_{i}^{t} ) \qquad ( 6 )$$

where v^{t}ᵢ is the velocity after modulation, v^{-t}ᵢ, is the tentative velocity, h^{K}_{I}(x^{t}ᵢ) represents the internal state of the node 102 for the region index determined by the nearest region query and x^{t}ᵢ−I(x^{t}ᵢ) is the relative position of the agent 104 within the region.

$${h}_{ij}^{k + 1} = H ( {h}_{ij}^{k} , {⊕}_{kl ∈ 𝒩 ij} EConv ( {x}_{ij} - {x}_{kl} , {h}_{kl}^{k} ) ) . \qquad ( 7 )$$

Equation (7) may describe an iterative updating process for the internal state representation, denoted as hᵢⱼ, within the deployed node 102. The update may be performed through an Edge Convolution (EConv) mechanism, that may be essential for capturing evolving information and relationships within a graph structure. In the equation (8), H function may be responsible for updating the internal state and is applied iteratively. The result of the update may be denoted as h_{k+1, ij}, indicating the internal state at the k+1^{th} iteration. Further, h_{k,ij} may represent a current internal state at the k^{th} iteration. ⊕ symbolizes an element-wise addition or another form of combining the information. Nᵢⱼ refers to a neighborhood of the ij^{th} region in the graph. Further, xᵢⱼ denotes the spatial coordinates of the center of the ij^{th} region. EConv (xᵢⱼ−xₖₗ,h^{k}ₖₗ) denotes the Edge Convolution mechanism, that may be applied to relative positions (xᵢⱼ−xₖₗ) and hidden states (h_{k,kl}) of the regions in the neighborhood.

The determined velocity (e.g., modulated velocity) may be based on the preferred travel direction that may align with the tentative velocity as defined through equation (8):

$$\prod * ( {x}_{i}^{t} , {g}_{i} ) = {argmax}_{v ∈ VI ( {x}^{t} i )} 〈 v , {v}_{i}^{- t} 〉 \qquad ( 8 )$$

where Π* denotes an expert policy that takes two parameters such as, the current position x^{t}ᵢ and the destination gᵢ, indicating that the determination of the modulated velocity is influenced by the current position and the destination of the agent 104. Further, an argmax operator may be used to find an argument (velocity vector v) that maximizes a certain expression, v∈V_{I}(x^{t}ᵢ) may specify that the velocity vector v belongs to a set V_{I}(x^{t}ᵢ), where V_{I} represents the set of allowed velocities for the agent 104 at its current position, v,v^{-t}ᵢ represents a dot product between the velocity vector v and the reference velocity vector v^{-t}ᵢ and angle brackets denote a dot product operation. Further discussion of baseline comparison determinations may be found in Learning Neural Traffic Rules, by Zhang et al, arXiv:2312.01498, 3 Dec. 2023, published at https://arxiv.org/abs/2312.01498, herein incorporated by reference in its entirety, and for which the inventors of this application are also authors.

The node interaction module 204 may be configured to transmit the modulated velocity (e.g., the preferred direction of travel) to the communication module 206.

Further, the communication module 206 may be configured to transmit the modulated velocity to the corresponding agent 104. The communication module 206 may be configured to transmit the modulated velocity to the corresponding agent 104 through a communication means. The communication means may be, but is not limited to, a direct communication, broadcast, wired or wireless communication, environment cues, and so forth. Aspects are intended to include or otherwise cover any type of the communication means, including known, related art, and/or later developed technologies.

Further, the velocity modulation module 208 may be configured to enable the agent 104 to update navigation parameters upon receiving the modulated velocity. The velocity modulation module 208 may be configured to enable the agent 104 to adjust its velocity based on the modulated velocity. The velocity modulation module 208 may be configured to enable the agent 104 to travel in the modulated velocity from the current position to the destination.

Further, the monitoring module 210 may be configured to continuously monitor the position of the corresponding agents 104 for determining the current position of the agents 104. The monitoring module 210 may be configured to determine whether the corresponding agents 104 have reached their assigned destination or not by comparing the current position of the corresponding agents 104 with the destination. The monitoring module 210 may be configured to transmit the query to the node interaction module 204, when the current position of the at least one of, the agents 104 is not equal to the corresponding destination. In another aspect, the monitoring module 210 may be configured to generate a destination reached signal, when the current position of the relevant agent 104 is equal to its corresponding destination, which indicates that that agent 104 has reached its corresponding destination successfully. The monitoring module 210 may be configured to transmit the generated destination reached signal to the storage module 212.

The storage module 212 may be configured to store information associated with an arrival of the corresponding agent 104 on the destination upon receiving the destination reached signal from the monitoring module 210. The storage module 212 may be configured to store the information in the database 114. The storage module 212 may be configured to store other information of the arrived agent 104 in the database 114. The other information may include, but is not limited to, a timestamp, an agent ID, a starting location, a path taken, a travel duration, congestion information, and so forth. Aspects are intended to include or otherwise cover any type of the information of the agents 104.

FIG. 3 is an illustrative environment 300 for performing multi-agent navigation. Consider a first scenario that employs an environment-centric method (a) with GRNN (b) an encoded traffic rules (c) for organized navigation in a city.

In this scenario, the city may be divided into discrete regions 302a-302p (hereinafter collectively referred to as the regions 302 and individually referred to as the region 302), each representing a neighborhood or a distinct section of the city. The regions 302 may be created to facilitate the organized navigation within the city. Further, there may be two distinct groups of vehicles such as, first cars 304a-304b (hereinafter referred to as the first cars 304) and second cars 306a-306c (hereinafter referred to as the second cars 306). The first cars 304 and the second cars 306 may be having specific destinations represented by first hollow circles 308a-308b (hereinafter referred to as the first hollow circles 308) and second hollow circles 310a-310c (hereinafter referred to as the second hollow circles 310) respectively. Further, GRNN nodes 312a-312p (hereinafter referred to as the GRNN nodes 312) may be deployed across the corresponding regions 302 for navigation, particularly in scenarios where the first cars 304 and the second cars 306 are navigating towards their designated destinations such as the first hollow circles 308 and the second hollow circles 310. Before a navigation task begins, the GRNN nodes 312 may undergo an inference process, where recurrent units within the GRNN nodes 312 may update the internal state of each region 302 and may encode the essential set of traffic rules. The inference process may be performed only once and does not necessarily need to be performed each time a navigation task starts. The inference process may be performed for only one GRNN node 312 and the same result of the inference process may be applied to other GRNN nodes 312. Upon encoding the essential set of traffic rules, each of the first cars 304 and the second cars 306 may calculate a corresponding shortest path (d) to yield a tentative velocity (e) for reaching to the designated destinations represented by the first hollow circles 308 and the second hollow circles 310. Further, both the first cars 304 and the second cars 306 may index the corresponding regions 302 in which the first cars 304 and the second cars 306 reside and then query a Rule Following Unit (RFU) 314 of the corresponding regions 302 to obtain information about the traffic rules relevant to the region 302 they reside within. The GRNN nodes 312 of the corresponding regions 302, based on recurrent connections and the encoded parameters (e.g., set of traffic rules), may provide guidance on how each of the first cars 304 and the second cars 306 needs to navigate within its respective regions 302. Each of the GRNN node's 312 response may include adjustments to the tentative velocity (e) resulting in congestion-free modulated velocity (g) of the first cars 304 and the second cars 306. This scenario helps in resolving congestion and ensuring a smooth flow of traffic.

In a scenario, all agents (not shown) may be assumed to have circular agents moving in a rectangular environment with rectangular obstacles. Further, a position of an agent (i^{th}) at a given time step (t) is denoted by x^{t}ᵢ in a two-dimensional space. The primary goal may be collision-free traversal from an initial position (x⁰ᵢ) to a predefined goal location (gᵢ). In this scenario, local navigation algorithms may be employed, driven by desired velocities (v^{t}ᵢ) for each agent. The desired velocities (v^{t}ᵢ) (e.g., local collision free velocities) for each agent may override the modulated velocity for the agent if a collision is anticipated to happen based on the modulated velocity. An optimization problem may ensure collision avoidance, minimizing a deviation from the desired velocities while maintaining 2r separation distance between the agents. In this scenario, an overarching aim of the present application is to develop a neural navigation policy predicting the desired velocities for efficient navigation while minimizing congestion instances. Further, in this scenario, it is assumed that the agents may be having limited computational resources and restricted communication capabilities. Computational capabilities may be confined to computing local collision-free velocities, and communication may be asynchronous that may allow the agents to gather information independently but prohibiting direct coordination of motion. In some instances, a neural network may be used to approximate one or more desired velocities, as represented by Equation (9):

$${argmin}_{{x}_{i}^{t + 1}} {\sum }_{i} {‖ {x}_{i}^{t + 1} - {x}_{i}^{t} - {v}_{i}^{t} ‖}^{2} \qquad ( 9 )$$

$$s . t . ‖ {x}_{i}^{t + γ} - {x}_{j}^{t + γ} ‖ \geq 2 r ∀ i \neq j ⋀ γ ∈ [ 0 , 1 ] ,$$

In equation (9), a position of the i^{th} agent at the t^{th} time step is denoted as x^{t}ᵢ∈R2. Further v^{t}ᵢ represents the desired velocity for each agent at each time step, and then output the positions of the agents. Also, x^{t+γ}ᵢ denotes the interpolated position of the agent at a fractional time instance t+γ. x^{t+1}ᵢ denotes a position of the i^{th} agent at the next time step (t+1). Further, |x^{t+γ}ᵢ−x^{t+γ}ⱼ∥≥2r ensures that the distance between any two agents (i and j) at the next time step (t+1) is greater than or equal to twice the radius (2r) to avoid collisions.

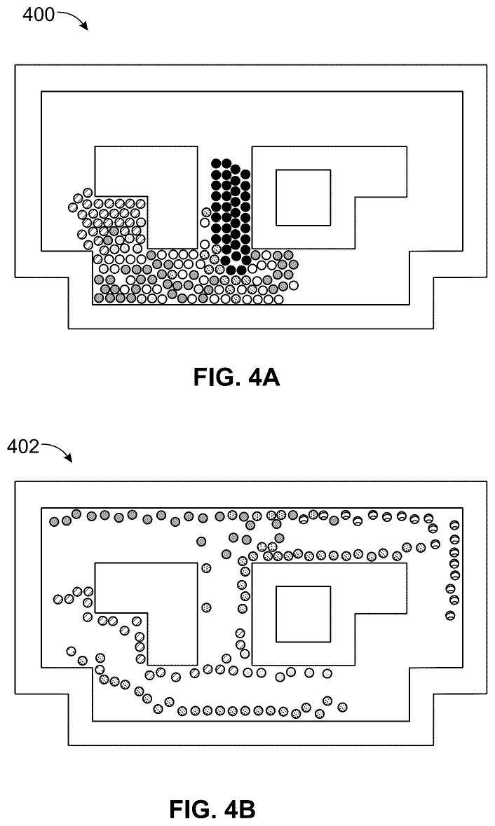

FIG. 4A illustrates a baseline congestion scenario 400. The baseline scenario 400 may depict a congested situation, implying that an initial navigation strategy leads to traffic congestion among the agents 104 (as shown in the FIG. 1). In an example, the agents 104 within the baseline scenario 400 may be differentiated by color, with each color representing a distinct group of agents 104. Further, the congestion may arise due to factors such as, but not limited to, inefficient route planning, lack of coordination, collisions between the agents 104, and so forth. The color-coded representation of the agents 104 may be used for visually distinguishing between different groups within the scenario 400. The differentiation may be based on factors such as, but not limited to, an agent type, a role, or any other categorization relevant to a navigation context. By coloring the agents 104, the visualization may provide a clear way to identify and track the movements of specific groups throughout the scenario 400.

FIG. 4B illustrates a Reinforcement Learning (RL) congestion scenario 402. The Reinforcement Learning (RL) congestion scenario 402 may depict a congestion-free scenario that may be achieved by a refined Reinforcement Learning (RL) strategy. As used herein, the term “congestion-free” may suggest that implemented improvements have successfully alleviated or eliminated traffic congestion issues. The agents 104, that are still colored according to their respective groups, may now be navigating through the predetermined space without encountering congestion-related challenges.

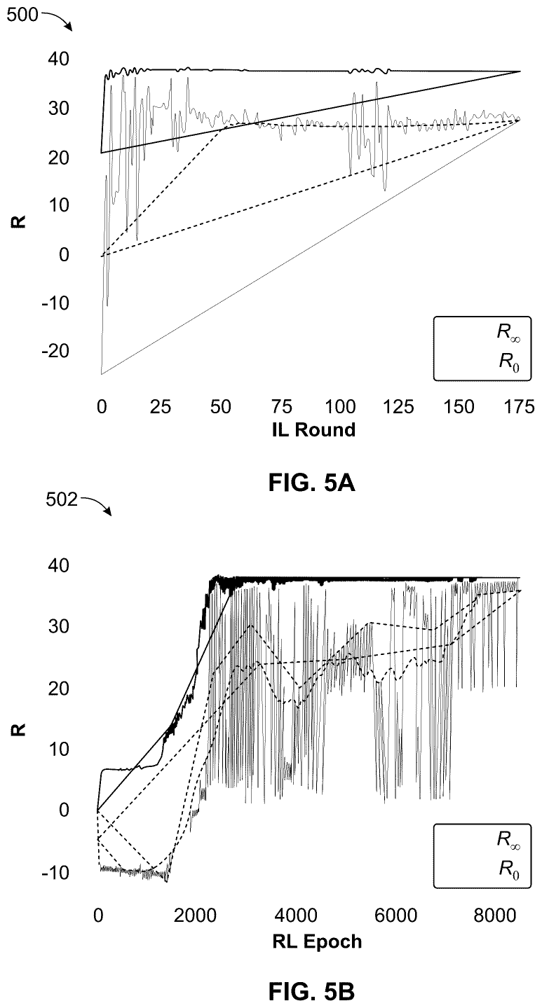

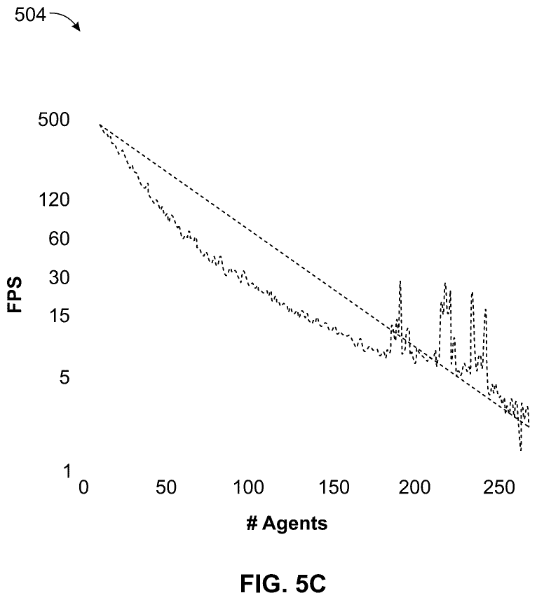

FIG. 5A illustrates an Imitation Learning (IL) convergence history 500. A convergence analysis that centers around two key metrics such as, R0 and R∞, may be plotted against an index of Iterative Learning (IL) rounds. As used herein, the term “Convergence” refers to a property where a sequence of values or solutions approaches a stable or steady-state condition, and the term “analysis” aims to evaluate a convergence behavior in a specific algorithm or process. Further, the metrics such as, R0 and R∞, may serve as indicators of a convergence status and may represent different criteria or performance aspects relevant to an analyzed problem. The index of the IL rounds may denote iterations or cycles of an Iterative Learning process, showcasing a sequential order of these rounds.

The convergence history 500 may be visually depicted on a plot, with x-axis corresponding to the index of IL rounds and y-axis representing the values of the convergence metrics. Notably, the history of three distinct runs may be superimposed on the same plot, with each run differentiated by a specific lines such as, dark solid line, solid line, and dotted line. The use of different lines may serve to emphasize the consistency of a method across multiple runs. In other words, the convergence history plot 500 may serve as a valuable tool in iterative algorithms and optimization processes, providing a means to assess performance and convergence behavior over multiple runs.

FIG. 5B illustrates Reinforcement Learning (RL) convergence history 502. A comprehensive convergence analysis may be conducted during a Reinforcement Learning (RL) training process, where a focus is on two critical metrics such as, R0 and R∞. The metrics may be graphically depicted on a convergence history plot 502, with the x-axis denoting the index of RL iteration and the y-axis representing the values of R0 and R∞. The convergence history plot 502 may serve as a visual tool to gain insights into the behavior and performance of the RL algorithm throughout successive iterations.

A superimposition of three distinct runs onto the same plot, may be distinguished by different lines such as, dark solid line, solid line, and dotted line, facilitates a comparative analysis. The use of varied colors may be employed to emphasize method's reliability, suggesting that, despite potential randomness or variability inherent in the RL training process, the algorithm may consistently converge to similar outcomes across different runs.

FIG. 5C illustrates a comparison 504 of runtime total inference cost (in milliseconds) between the environment-centric approach and the agent-centric approach. The evaluation may be conducted by averaging runtime costs over 10 runs on test scenarios, offering a robust assessment of the computational efficiency of each approach. The comparison may focus on the utilization of Graph Recurrent Neural Networks (GRNNs) to parameterize the policy in both approaches. The results presented in the FIG. 5C demonstrate that the environment-centric approach achieves significantly enhanced performance compared to the agent-centric approach. The runtime total inference cost peaks at 400 milliseconds while effectively managing a cohort of 240 agents 104. This outcome underscores the efficiency of the environment-centric approach, particularly in terms of computational speed, as it outperforms the agent-centric approach that necessitates repeated GNN inference on the agent network.

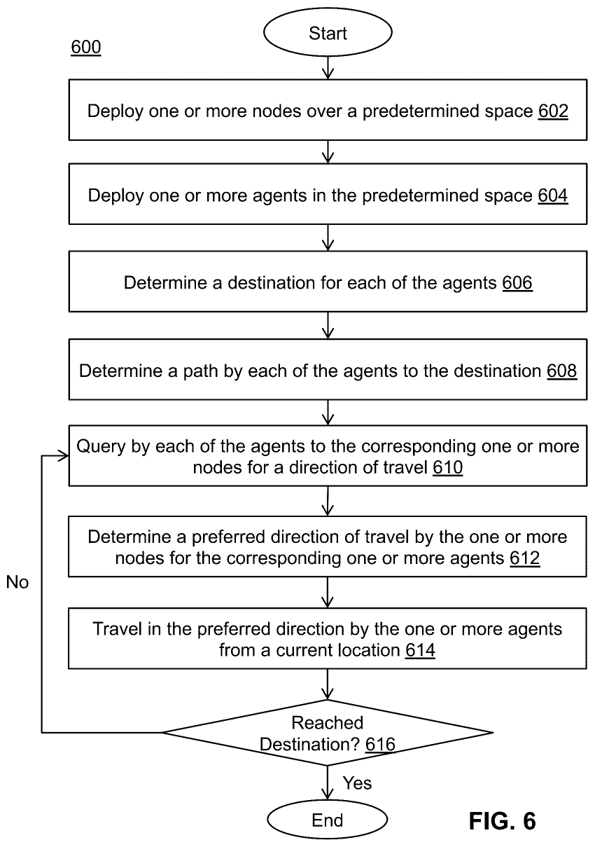

FIG. 6 illustrates a flowchart of a method 600 of performing autonomous navigation by using the system 100, according to illustrative aspects described herein.

At step 602, the system 100 may deploy the nodes 102 over the predetermined space. Each of the nodes 102 may be associated with the corresponding regions of the predetermined space such that each of the nodes 102 may be trained based on the predetermined set of traffic rules.

At step 604, the system 100 may deploy the agents 104 in the predetermined space. Each of the agents 104 may be associated with the starting location.

At step 606, the system 100 may determine the destination for each of the agents 104.

At step 608, the system 100 may enable the agents 104 to determine the path to the destination assigned to the corresponding agents 104.

At step 610, the system 100 may query at least one of the nodes 102 associated with at least one of the corresponding regions encompass the current position of the corresponding agents 104 to determine the direction of travel.

At step 612, the system 100 may enable the at least one of the nodes 102 to determine the preferred direction of travel for the corresponding agents 104 based on the predetermined set of traffic rules.

At step 614, the system 100 may transmit the preferred direction of travel from the at least one of the nodes 102 to the corresponding agents 104.

At step 616, the system 100 may enable the corresponding agents 104 to travel in the preferred direction from the current position to the destination.

At step 618, the system 100 may determine whether the current position of the corresponding agents 104 is equal to the assigned destination or not. In case, the system 100 may determine that the current position of the corresponding agents 104 is equal to the assigned destination, then the method 600 may conclude. Otherwise, in case, the system 100 may determine that the current position of the corresponding agents 104 is not equal to the assigned destination, then the method 600 may return to the step 610 and continues to query the at least one of the nodes 102. Although the invention has been described with reference to illustrative aspects, it is not limited thereto. Those skilled in the art will appreciate that numerous changes and modifications may be made and that such changes and modifications may be made without departing from the true spirit of the invention. It is therefore intended that the appended claims be construed to cover all such equivalent variations as fall within the spirit and scope of the invention.

The illustrative aspects have been described in relation to multi-agent navigation systems and methods. However, to avoid unnecessarily verbiage, the preceding description may omit a number of known structures and devices. This omission is not to be construed as a limitation of the scope of the claims. Specific details are set forth by use of the illustrative aspects to provide an understanding of the present invention. It should however be appreciated that the present invention may be practiced in a variety of ways beyond the specific aspects set forth herein.

The present application, in various examples, embodiments, configurations, and aspects, includes components, methods, systems and/or apparatus substantially as depicted and described herein, including various examples, embodiments, sub-combinations, and subsets thereof. Those of skill in the art will understand how to make and use the present invention after understanding the present disclosure. The present application, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

What is claimed is:

1. A method of performing autonomous navigation, comprising:
deploying a plurality of nodes over a predetermined space, wherein each of the plurality of nodes is associated with a corresponding one or more regions of the predetermined space, and wherein each of the one or more nodes is trained based on a predetermined set of traffic rules;
deploying a plurality of agents in the predetermined space, wherein each of the plurality of agents is associated with a starting location;
determining a destination for each of the plurality of agents;
determining, by each of the plurality of agents, a path to the destination corresponding to that agent;
querying, by each agent, at least one of the nodes associated with the corresponding region encompassing a current position of the agent, to determine a direction of travel;
determining, by at least one of the queried nodes, a preferred direction of travel for the querying agent based on the predetermined set of traffic rules;
sending the preferred direction of travel from the queried node to the querying agent; and
travelling, by the querying agent, in the preferred direction from the current position of the agent.

2. The method of claim 1, wherein the predetermined set of traffic rules are generated based on a machine learning model.

3. The method of claim 1, wherein one or more of the regions are non-overlapping in the predetermined space.

4. The method of claim 1, wherein each of the one or more agents lacks computational resources to determine the preferred direction of travel within a predetermined time interval.

5. The method of claim 1, wherein the starting location associated with each of the one or more agents is different from other starting locations of all other agents.

6. The method of claim 1, wherein the destination of each of the one or more agents is unique.

7. The method of claim 1, wherein the same predetermined set of traffic rules is used for training each of the one or more nodes.

8. The method of claim 1, wherein each of the one or more agents comprise a physical vehicle.

9. The method of claim 1, wherein each of the one or more agents comprise a virtual agent in a simulated environment.

10. The method of claim 1, wherein the direction of travel comprises a speed component.

11. The method of claim 1, wherein the path determined by each of the one or more agents is a shortest path from the current position of the corresponding one or more agents to the assigned destination, wherein determining, by the at least one of the nodes, the preferred direction of travel for the corresponding one or more agents is based on the shortest path.

12. The method of claim 1, further repeating steps of querying the at least one of the nodes associated with at least one of the corresponding regions encompass a current position of the corresponding one or more agents, determining, by the at least one of the nodes, the preferred direction of travel for the corresponding one or more agents based on the predetermined set of traffic rules, sending the preferred direction of travel from the at least one of the nodes to the corresponding one or more agents, and enabling the corresponding one or more agents to travel in the preferred direction from the current location to the destination until the current position of the corresponding one or more agents is equal to the assigned destination.

13. The method of claim 1, wherein the one or more nodes are Graph Recurrent Neural Network (GRNN) nodes.

14. A multi-agent navigation system, comprising:
a navigation implementation module configured to:
deploy one or more nodes over a predetermined space, wherein each of the one or more nodes are associated with corresponding one or more regions of the predetermined space;
train each of the one or more nodes by using predetermined set of traffic rules stored in a database;
deploy one or more agents within the predetermined space, wherein each of the one or more agents is associated with a starting location; and
determine a destination for each of the one or more agents;
a path calculation module configured to enable the one or more agents to determine a path to the destination assigned to the corresponding one or more agents;
a node interaction module configured to:
query at least one of the nodes associated with at least one of the corresponding regions encompass a current position of the corresponding one or more agents, to determine a direction of travel; and
enable the at least one of the nodes to determine the preferred direction of travel for the corresponding one or more agents based on the predetermined set of traffic rules;
a communication module configured to transmit the preferred direction of travel from the at least one of the nodes to the corresponding one or more agents; and
a monitoring module configured to determine the current position of the corresponding one or more agents is equal to the assigned destination or not.

15. The system of claim 14, wherein the predetermined set of traffic rules are generated based on a machine learning model.

16. The system of claim 14, wherein each of the one or more agents lack computational resources to determine the preferred direction of travel within a predetermined time interval.

17. The system of claim 14, wherein the path determined by each of the one or more agents is a shortest path from the current position of the corresponding one or more agents to the assigned destination, wherein the preferred direction of travel determined by the at least one of the nodes is based on the shortest path.

18. The system of claim 14, wherein the one or more nodes are Graph Recurrent Neural Network (GRNN) nodes.

19. The system of claim 14, wherein the direction of travel comprises a speed component.

20. A non-transitory computer readable medium storing instruction that, when executed by a computer, perform a process of performing autonomous navigation, comprising:
deploying one or more nodes over a predetermined space, wherein each of the one or more nodes is associated with corresponding one or more regions of the predetermined space such that each of the one or more nodes is trained based on a predetermined set of traffic rules;
deploying one or more agents in the predetermined space, wherein each of the one or more agents is associated with a starting location;
determining a destination for each of the one or more agents;
determining, by each of the one or more agents, a path to the destination assigned to the corresponding one or more agents;
querying at least one of the nodes associated with at least one of the corresponding regions encompass a current position of the corresponding one or more agents, to determine a direction of travel;
determining, by at least one of the nodes, the preferred direction of travel for the corresponding one or more agents based on the predetermined set of traffic rules;
sending the preferred direction of travel from the at least one of the nodes to the corresponding one or more agents;
enabling the corresponding one or more agents to travel in the preferred direction from the current location to the destination; and
determining the current position of the corresponding one or more agents is equal to the assigned destination or not.
